(19) United States
(12) Patent Application Publication
(10) Pub. No.: US 2024/0354120 A1
(43) Pub. Date: Oct. 24, 2024

(54) CONTROLLER PROXY

(71) Applicant: International Business Machines Corporation, Armonk, NY (US)

(72) Inventors: Xin Xin Dong, Beijing (CN); Wei Song, Beijing (CN); Mai Zeng, Shi Jing Shan (CN); Ming Qiao Shang Guan, Haidian District (CN); Peng Hui Jiang, Beijing (CN); Wen Zhong Liu, Haidian District (CN)

(21) Appl. No.: 18/137,519

(22) Filed: Apr. 21, 2023

(51) Int. Cl. G06F 9/445; G06F 11/34

(52) U.S. Cl. CPC G06F 9/44505; G06F 11/3495

(57) ABSTRACT

An automatic triggering alert for changing a controller proxy in a computer cluster environment can be received, based on monitoring the computer cluster environment and policy rules associated with the computer cluster environment. The triggering alert can be broadcast to a plurality of agents in the computer cluster environment. Candidate proxies among the plurality of agents can be determined. For each of the candidate proxies, a system health status based on a prediction model's forecast and a policy compliance score based on the policy rules can be determined. Based on the system health status and the policy compliance score associated with each of the candidate proxies, a new controller proxy among the candidate proxies can be selected for the computer cluster environment. The new controller proxy can be notified to perform management of the computer cluster environment.

### BACKGROUND

The present application relates generally to computers and computer applications, and more particularly to intelligent selection of controller proxy in a computer cluster environment.

### BRIEF SUMMARY

The summary of the disclosure is given to aid understanding of a computer system and method of choosing controller proxy, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

A method, in an aspect, can include receiving an automatic triggering alert for changing a controller proxy in a computer cluster environment based on monitoring the computer cluster environment and policy rules associated with the computer cluster environment. The method can also include broadcasting the triggering alert to a plurality of agents in the computer cluster environment. The method can further include determining candidate proxies among the plurality of agents. The method can also include, for each of the candidate proxies, determining a system health status based on a prediction model's forecast and determining a policy compliance score based on the policy rules. The method can also include, based on the system health status and the policy compliance score associated with each of the candidate proxies, selecting a new controller proxy among the candidate proxies for the computer cluster environment. The method can further include notifying the new controller proxy to perform management of the computer cluster environment.

A system, in an aspect, can include a processor. The system can also include a memory coupled with the processor. The processor can be configured to receive an automatic triggering alert for changing a controller proxy in a computer cluster environment based on monitoring the computer cluster environment and policy rules associated with the computer cluster environment. The processor can also be configured to broadcast the triggering alert to a plurality of agents in the computer cluster environment. The processor can also be configured to determine candidate proxies among the plurality of agents. The processor can also be configured to, for each of the candidate proxies, determine a system health status based on a prediction model's forecast and determine a policy compliance score based on the policy rules. The processor can also be configured to, based on the system health status and the policy compliance score associated with each of the candidate proxies, select a new controller proxy among the candidate proxies for the computer cluster environment. The processor can also be configured to notify the new controller proxy to perform management of the computer cluster environment.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows an example of a computing environment, which can implement intelligent selection of controller proxy in an embodiment.

FIG. 2 is a diagram illustrating a system architecture in an embodiment.

FIG. 3 shows another system architecture of computer cluster environment in an embodiment.

FIG. 4 shows an example of decision making for selecting a controller proxy in an embodiment.

FIG. 5 shows an example of switching controller proxies in an embodiment.

FIG. 6 is a flow diagram illustrating a method of decision making in selecting a controller proxy in a cluster environment in an embodiment.

FIG. 7 is another flow diagram illustrating a method of selecting a controller proxy in a computer cluster environment in an embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as intelligent selection of controller proxy code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

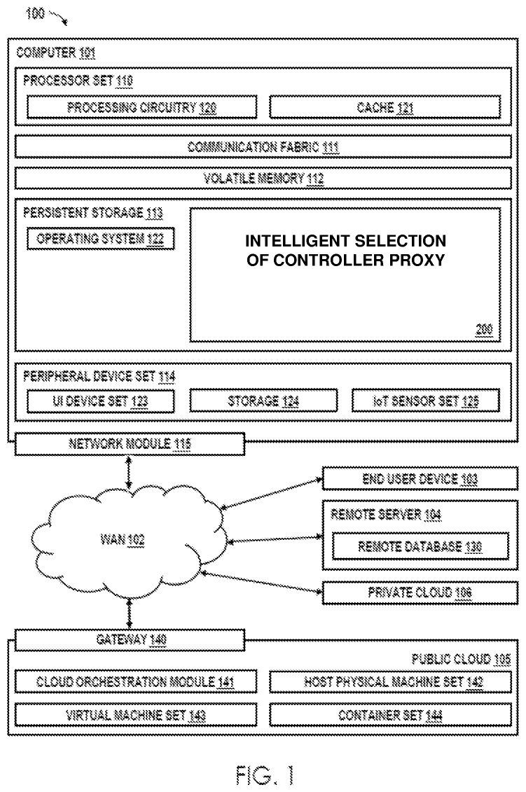

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

A computer cluster (also referred to herein as a cluster) is a set of computers (e.g., two or more computers) that are connected in a network, and that work together. For example, each computer in the cluster can have a server or another resource that runs on the computer, and work with other computers in the cluster, for example, in supporting applications, middleware such as databases, and/or others. For example, a computer cluster performs a specific task such as load balancing, large-scale processing, or the like. Each computer in the cluster can also be referred to as a node. Each computer or node in a cluster usually performs the same task as the rest of the nodes in the cluster, for example, such that a computer cluster can provide faster processing speed, wider availability of resources (e.g., larger storage capacity), better reliability (e.g., even when there is a fault in one of the nodes in the cluster, other can still function), and high-performance computing. For instance, the nodes in the cluster can run in parallel to achieve a common goal or function.

A cluster agent (also referred to herein as an agent) can be a computer process or application that runs on a computer in a cluster. In another aspect, a computer or a node in the cluster can be referred to as a cluster agent. For example, each computer in the cluster can have or be a cluster agent.

A controller proxy can be a computer application running on a computer in a cluster, that may manage and administer other computers or cluster agents in the cluster. For instance, a cluster agent among all cluster agents in a cluster can be assigned a status of being a controller proxy. Both the controller proxy agent and non-controller proxy agents can be applications running on a computer or node in a cluster. The controller proxy agent can be a special agent which can manage cross-system wide resources such as manage partitions, monitoring and sharing functions. A controller proxy, for example, may manage states of the partitions or resources in the cluster, replicas, handle administrative tasks associated with the cluster such as reassigning partitions, monitoring and sharing functions, act as a data consolidation point, for global management among the nodes of the cluster.

In some cluster environments, a controller proxy is required to be an agent with the highest version number. In other cluster environments, a controller proxy can be assigned based on one or more policies or rules. Based on one or more policies, or one or more other events (e.g., the current controller proxy goes offline), the controller proxy may need to be switched. For example, if the agents have different version levels, and a new agent is added to the cluster, the current controller proxy may need changing, since the new agent may be at a higher version level. In an environment where the agents all have the same version level, a decision needs to be made as to which agent should take the status of being a controller proxy. In one or more embodiments, one or more systems, methods and/or techniques can be provided for intelligently selecting a controller proxy among the cluster agents in a cluster, e.g., intelligently assigning a status of controller proxy to a cluster agent in a cluster.

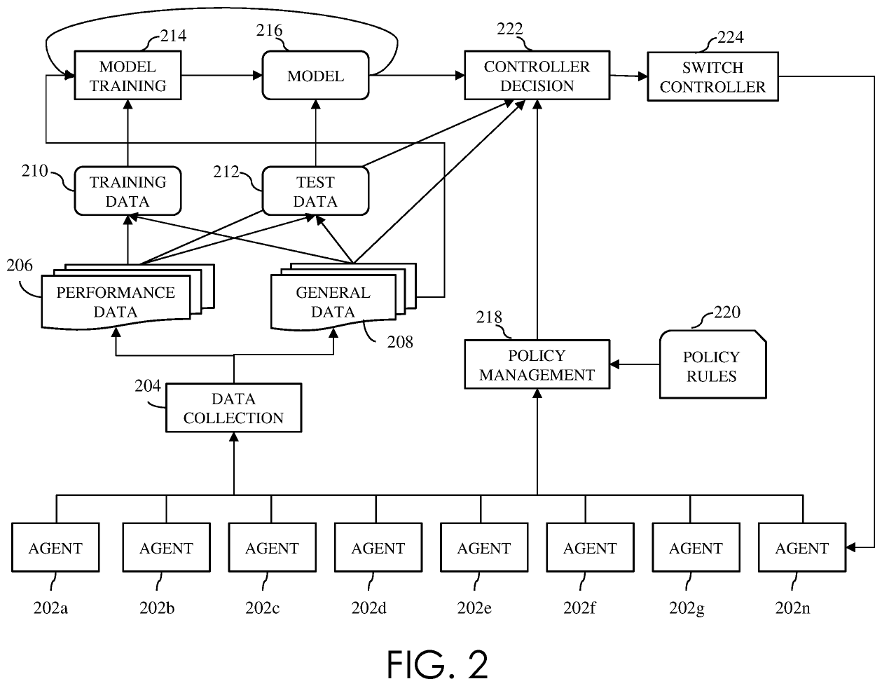

FIG. 2 is a diagram illustrating a system architecture in an embodiment. Cluster agents 202a, 202b, 202c, 202d, 202e, 202f, 202g, 202n, can be applications running on computers or nodes in a computer cluster environment. For instance, a cluster agent can be an application running on a computer. A computer or node in a cluster can have a cluster agent running on it. For instance, each computer or node in a cluster can have at least one cluster agent running on it. There can be two or more cluster agents in a cluster. Data collection 204 can be a computer function or code, also referred to as a data collection module (DCM), running on a computer processor and can perform data collection. Data collection 204 collects performance data 206 and general data 208 about the agents 202a-202n, for example, information about agents in a computer cluster and resource usage in the cluster. For example, the information collected can include, but not limited to, general information such as: cluster name, node name, agent name, agent version and maintenance level, controller proxy name, controller proxy version and maintenance level; and performance information such as: timestamps, central processing unit (CPU) utilization, workload activities, user count. The data collected can be historic data and real time data. For example, data collection 204 can collect data in real time, and store that data. Stored data that is accumulated becomes historic data. Historic data can be used to train a prediction model. Real time data that is collected can also be used for inference stage of a prediction model. Data collection 204 can also include formatting the collected data, for example, for use.

Table 1 shows examples of general information.

TABLE 1

| | | | | Agent | | |
|---|---|---|---|---|---|---|
| Cluster | Node | Agent | Agent | maintenance | Controller | Controller |
| Name | Name | Name | version | level | Proxy name | Proxy level |
| Cluster | A1 | A1TMS | V55 | 20220503 | A1 TMS | V55M20220503 |
| A | | Sys Proxy/ | | | | |
| | | Controller | | | | |
| | | Proxy | | | | |
| Cluster | A2 | A2TMS | V55 | 20220101 | A1 TMS | V55M20220503 |
| A | | | | | | |
| Cluster | B1 | B1TMS | V55 | 20220320 | B1 TMS | V55M20220320 |
| B | | Sys Proxy | | | | |
| Cluster | B2 | B2TMS | V53 | 20220530 | B2TMS | V55M20220320 |
| B | | | | | | |

Table 2 shows examples of performance information.

TABLE 2

| | Controller | | CPU | User | Agent | Workload |
|---|---|---|---|---|---|---|
| Timestamp | on | node | utilization | count | count | activity |
| 20230210.17:00:00 | Yes | A1 | 30% | 1000 | 20 | medium |
| 20230210.17:00:00 | No | A2 | 60% | 5000 | 40 | high |
| 20230210.17:10:00 | Yes | A1 | 33% | 1000 | 20 | medium |
| 20230210.17:10:00 | No | A2 | 10% | 300 | 40 | low |

Resource prediction module (RPM), function or process can use the collected performance data 206 and general data 208, in training a prediction model. Resource prediction module (RPM) can be a computer function or code running on a computer processor and include model training 214. Resource prediction module (RPM) can identify relevant data sets from the collected information, prepare them for building an analytical model (e.g., train an artificial intelligent mode), and choose the type of training algorithm to use. Building an analytical model based on a chosen algorithm can include generating a feature map, e.g., <f1, f2, f3, f2>, based on the collected information 206, 208, and also dividing the relevant data sets into training data 210 and test data 212. Model training 214 can perform artificial intelligence training using one or more supervised and/or unsupervised training techniques. Prediction model 216 can be a neural network based model or any other prediction model trained using one or more artificial intelligence training or machine learning techniques. Another example of a training technique can include k-nearest neighbor (KNN) algorithm. Prediction model 216 can be trained to forecast or predict system health of a cluster agent or of a node the cluster agent is running on, based on information (e.g., performance data 206, general data 208) collected by data collection 204. For example, the data 206, 208 can be divided into training data 210 and test data 212. Using training data 210, model training 214 trains a model 216. By way of example, for a prediction model 216 that is a neural network model, feature map or features can be input to the neural network and the weights of the neural network adjusted during learning based on ground truth labels. Using test data 212, the prediction model 216 that is trained can be tested, and revised or retrained based on the test results as needed.

Policy management 218 or policy management module 218 can be a computer function or code running on a computer processor. Policy management 218 can define and manage policies 220 of the cluster. In an embodiment, policy rules are in effect throughout the life cycle of an agent. There exists a list of rules that are to be considered when choosing the controller proxy for the cluster. Some examples of rules or policies can be related to events or factors such as, but are not limited to: agent startup, shutdown, version change, workload consideration, workday and holiday arrangements, and/or node activities. The following illustrates examples of policies:
Policy 1: An Agent should not be chosen as a Controller for day X, if that Agent is located in a locale where day X is considered a holiday
Policy 2: Controller should be located on the same node where Database Y workload runs
Policy 3: Controller should be located on the node where user count is less than 10,000
Policy 4: Controller should run on the node where workload activity is low

Controller decision 222 or controller decision module 222 can be a computer function or code running on a computer processor. Controller decision 222 makes decisions in controller proxy selection based on real time events occurring in the computer cluster such as a computer failure associated with a cluster agent, a new cluster agent in the cluster, one or more policy changes, and/or others. For instance, controller decision 222 makes decisions using policy management 218 events and the predictions of model 216. Controller decision 222 can be triggered or invoked to operate when, or in response to, any one or more of the events or criteria specified by the policies or policy rules 220 being met. Controller decision 222 can send a broadcast to agents 202a-202n, e.g., with information such as shown in the general information table. Every agent can receive the broadcast signal from controller decision 222, and can check if it is the highest version agent that can compete to be the new controller. The agents with the highest version can call or invoke the resource prediction module. In another aspect, the agents notify the resource prediction module that the agents have the highest version. Yet in another aspect, the resource prediction module may determine which agent or agents have highest versions. The resource prediction module can run or apply the trained model 214 using real time agent data (e.g., current general information and performance information), to get a score or health status of the agents. The resource prediction module can be notified or triggered for agents with the highest version. For instance, for each agent with the highest version, a processor can invoke the resource prediction module or run the trained model using the agent's real time general information and performance information. Policy rules 220 can be scanned to determine which of the agents complies with policy rules 220. In an embodiment, the agent with the highest or best score generated by the prediction model and with highest compliance with the policy rules can be elected as controller.

Switch controller 224 can be a computer function or code running on a computer processor. Switch controller 224 can generate switch scripts based on controller decision 222 making a controller proxy selection, and can also perform switching of the controller proxy based on the selection. Switch controller 224 may issue a switch process based on the script. For example, switch controller 224 may notify an agent (e.g., 202n) that its status is now changed to being a controller proxy, and for the agent (e.g., 202n) to take on the role of the controller proxy and perform operations related to controller proxy.

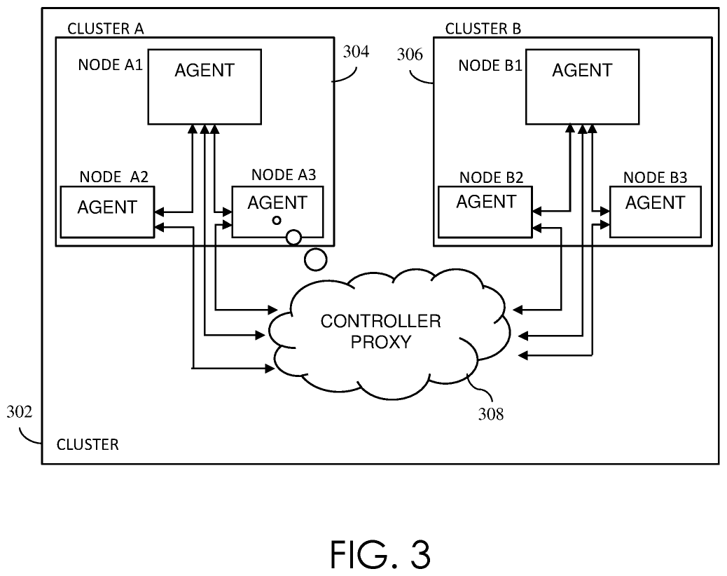

FIG. 3 shows another system architecture of computer cluster environment in an embodiment. A computer cluster environment 302 can also include multiple cluster (e.g., sub clusters) 304, 306, where each cluster has two or more nodes, each node having a cluster agent. A controller proxy 308 can be selected to manage all the agents in all the clusters.

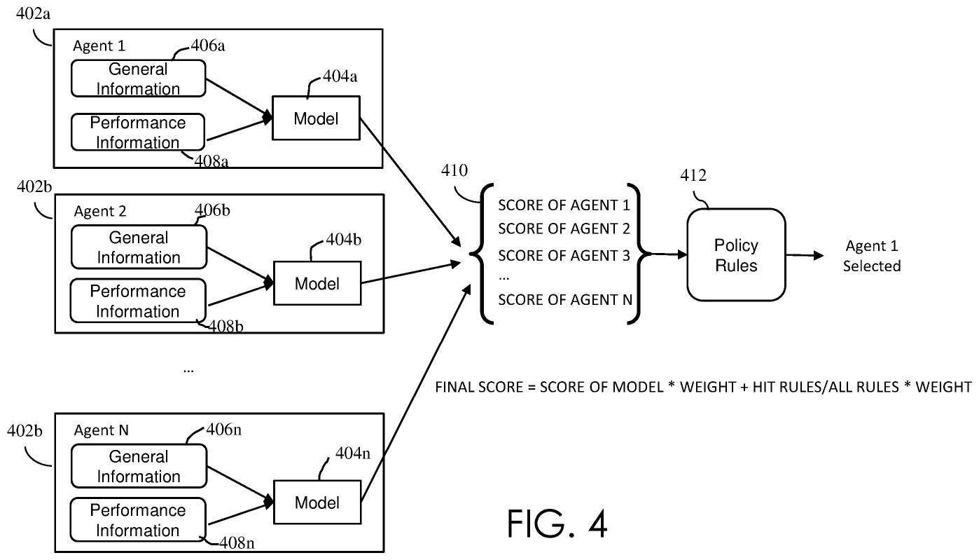

FIG. 4 shows an example of decision making process for selecting a controller proxy in an embodiment. For each agent, e.g., 402a, 402b, 402n, that is a candidate for selection as a controller proxy, a trained model 404a, 404b, 404n can be run using input data that includes general information 406a, 406b, 406n and performance information 408a, 408b, 408n. The trained model 404a, 404b, 404n, can be a generic model that can be used for all agents. In another embodiment, the trained model 404a, 404b, 404n can be specifically trained to predict for a specific agent, for example, a customized trained model for each agent. The models 404a, 404b, 404n output scores 410, each associated with an agent, e.g., score for agent 1, score for agent 2, score for agent n. Also, for each agent, rule compliance count or score can be determined by scanning each policy rule in policy rules 412. For instance, an agent with the highest compliance can receive the highest compliance score. For instance, a normalized computation of a policy compliance score can be: number of policies rules a given agent is compliant with divided by the total number of policies rules (e.g., hit rules/all rules). Based on the model output score and the policy compliance score, the control decision module can determine which agent to select as the new controller proxy. For example, an agent having the highest score output by the respect model and the highest policy compliance score can be selected. For example, a final score can be computed for each agent by combining the score output by a model and the policy compliance score. Such final score can be a weight sum of those scores: e.g., final score=score of model*weight1+policy compliance score*weight2. The weight values (e.g., weight1 and weight 2) can be preconfigured or provided by a user. Other scoring computations can be utilized.

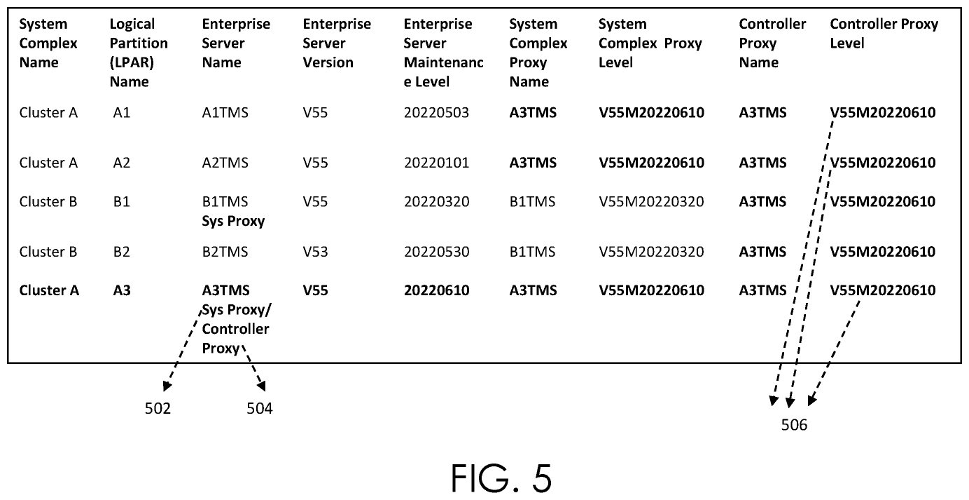

FIG. 5 shows an example of switching controller proxies in an embodiment. For example, consider that the previous statuses of proxies were as shown in Table 1 above. Switch controller (FIG. 2, 224) may generate a script for switching the controller proxy, for example, selected by controller decision module (FIG. 2, 222). For instance, consider that a new node A3 in cluster A has been added to the cluster and the controller decision module selected this node as the new controller proxy. An example of a script that is generated can include operations or commands such as follows: Switch controller proxy of cluster A to A3TMS (shown at 502); Switch controller proxy of the whole environment to A3TMS (shown at 504); Update general information table with new information (shown at 506). For example, referring to the table shown in FIG. 5, a cluster environment can include cluster A and cluster B, where cluster A has an assigned system proxy, cluster B has an assigned system proxy, and the cluster environment has an assigned proxy (controller proxy) for all of the clusters in the cluster environment. For example, cluster A's assigned system proxy is from its logical partition A3; cluster B's assigned system proxy is from its logical partition B1. The system and/or method described herein may assign cluster A's A3 partition (or a server or agent running on that partition) as the controller proxy for the cluster environment. In this example, switch controller (e.g., FIG. 2, 224) generates and/or runs scripts that perform switching controller proxy of cluster A to A3TMS 502, switching controller proxy of the entire cluster environment to A3TMS 504, and updating the general information table with new information 506.

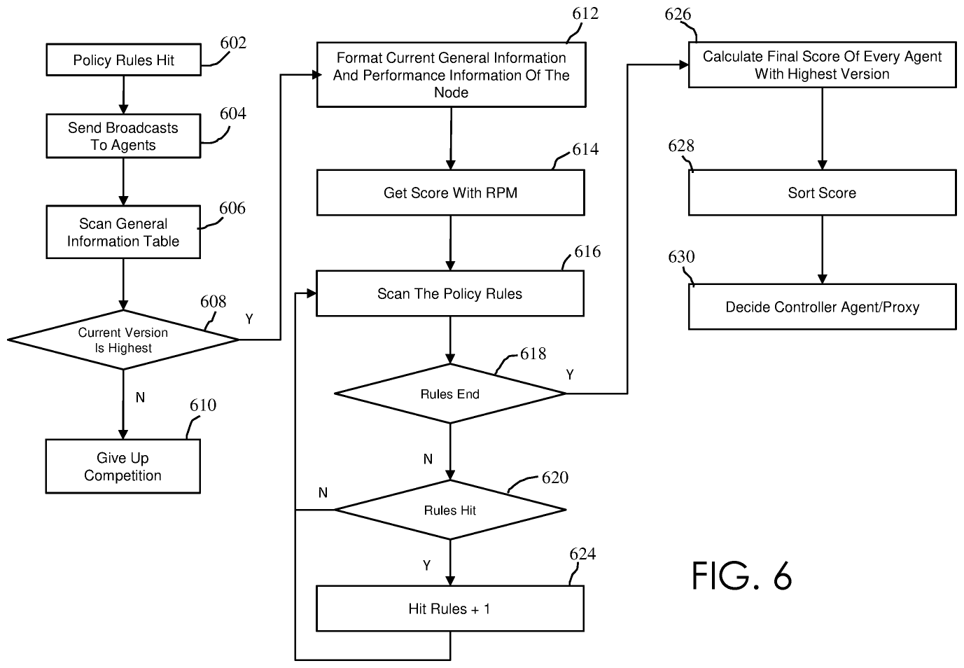

FIG. 6 is a flow diagram illustrating a method of decision making in selecting a controller proxy in a cluster environment in an embodiment. The method can be implemented or run on one or more hardware processors. At 602, occurrence of one or more events that meets one or more criteria of policy rules is detected. For example, a holiday approaches at a locale where a node that is currently assigned as a proxy controller is located. A new controller proxy should be assigned that is not located at that locale where it is a holiday. As another example, a new node is added, which may run on a higher version than the existing nodes, e.g., and hence, which can be considered for the role of a proxy controller. Such occurrences can invoke a control decision module (e.g., FIG. 2, 222) to begin considering a new proxy controller.

At 604, broadcasts can be sent to the nodes or agents of the nodes. For example, the control decision module may send such broadcast, for example, with information such as the information included in the general information table. At 606, each of the agents receives the broadcast and scans the information, e.g., received general information table, and determines whether it is one of the agents with the highest version number. For instance, the agent may compare its version number with those of other agents specified in the general information table. At 608, if the agent's current version is the highest among other agents in the cluster, the processing continues to 612. If at 608, the agent determines that its version is not the highest among the agents in the cluster, the processing proceeds to 610, where the agent may give up the competition for becoming the new controller proxy.

At 612, the current (e.g., real time) general information and performance information of the node where the agent is running can be formatted or prepared for prediction model inference. For example, feature maps or vectors can be generated based on the current general information and performance information for inputting to prediction model.

At 614, the prediction model is run, the model outputting a score associated with the node or the agent. For example, the resource prediction module may perform feature generation at 612 and running of the prediction model at 614. The score can be associated with the system health of the node, for example, resource usage, performance, and/or others.

At 616, for each agent, the policy rules can be scanned. At 618, if all the rules have been scanned, the method proceeds to 626, otherwise the method continues to 620. For instance, at 620, for each agent, a policy rule is tested against the agent, and based on that agent's compliance with the policy rule, that agent's policy compliance score is incremented at 624. Scanning through each policy rule and computing policy compliance score (e.g., 616 and 620) continues until all have been scanned (e.g., at 618).

At 626, combined score using the model output score and policy compliance score can be computed. An example formulation can be, but not limited to: score of model*weight1+policy compliance score*weight2. In an embodiment, the weight values (weight1, weight2) can be pre-configured and/or received from a user. A normalized weight value can be used, e.g., a value between [0, 1]. At 628, the combined score can be sorted, and at 628, the agent with the highest combined score can be selected as the new controller proxy for the cluster environment.

In an embodiment, a computer processor or hardware that is running the controller decision (e.g., FIG. 2, 222) may perform all of the processing shown in FIG. 6, for example, once it is triggered at 602. In another embodiment, some of the processing (e.g., 606, 608, 610) can be performed by individual nodes or agents of the nodes, for example, in parallel. In addition, the individual nodes or agents may also prepare and run the prediction model to obtain the model output associated with that agent (e.g., 612, 614). Scanning of the policy rules and computing a policy compliance score can also be performed by the individual nodes or agents for that node (e.g., 616-624). In one or more embodiments, in which the individual nodes or agents compute their own model output scores and/or policy compliance scores, the controller decision module may receive those scores and perform the processing at 626-630. In other embodiment, the controller decision module may perform determining of the model scores and policy compliance scores for the agents.

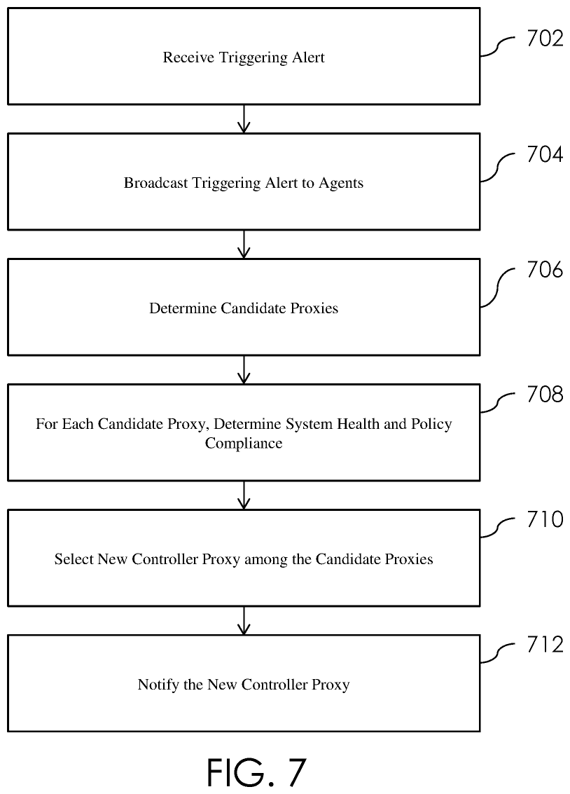

FIG. 7 is another flow diagram illustrating a method of selecting a controller proxy in a computer cluster environment in an embodiment. The method can be performed, implemented or run on one or more hardware processor or computer processors. At 702, the method can include receiving an automatic triggering alert for changing a controller proxy in a computer cluster environment based on monitoring the computer cluster environment and policy rules associated with the computer cluster environment. For instance, a controller decision module may receive such a trigger or triggering alert, for example, based on a policy management module monitoring events occurring associated with the cluster environment against one or more of the policy rules.

At 704, the method can include broadcasting the triggering alert to a plurality of agents in the computer cluster environment. For example, the controller decision module may send broadcasts to a plurality of agents.

At 706, the method can include determining candidate proxies among the plurality of agents. For example, candidate proxies can be determined based on their version numbers, e.g., ones with the highest or latest version numbers, ones with a threshold number of highest or latest version numbers. Determining candidate proxies among the plurality of agents can include receiving an indication of eligibility from the plurality of agents based on version numbers associated with the plurality of agents. For instance, each agent responsive to receiving the triggering alert may determine whether it is one of the agents having the highest version or allowed highest versions, and provide the indication of eligibility based on the determination. In another aspect, determining candidate proxies among the plurality of agents can include determining as the candidate proxies, agents that have the highest version numbers among the plurality of agents. In an embodiment, in the case a controller proxy is to be selected based on the highest version number and there is only one candidate that meets that criteria, the method may include selecting that candidate as the new controller proxy.

At 708, for each of the candidate proxies, the method can include determining a system health status based on a prediction model's forecast and determining a policy compliance score based on the policy rules. Determining a system health status based on a prediction model's forecast can include generating a feature map using real time data associated with a candidate proxy among the candidate proxies, and inputting the feature map into the prediction model to forecast the system health status of the candidate proxy. Determining a policy compliance score based on the policy rules can include comparing the policy rules against a candidate proxy's current system attributes, computing the policy compliance score based on a number of the policy rules the candidate proxy is compliant with.

At 710, the method can include, based on the system health status and the policy compliance score associated with each of the candidate proxies, selecting a new controller proxy among the candidate proxies for the computer cluster environment. Selecting a new controller proxy among the candidate proxies can include, for each of the candidate proxies, computing a combined weighted score using the system health status and the policy compliance score; and

selecting candidate proxy having the highest combined weighted score as the new controller proxy.

At 712, the method can include notifying the new controller proxy to perform management of the computer cluster environment. The method can also include training the prediction model to predict at least system resource usage and performance metric of an agent using historical information associated with the plurality of agents in the computer cluster environment.

The system and/or method disclosed herein can switch controller proxy automatically, for example, based on one or more events or factors such as, but not limited to, activities among nodes and policy changes. The system and/or method may also rationalize the use of controller based on the use of system resources. In an aspect, controller proxy switching may be performed automatically without having to shutdown agents manually. A controller proxy can be chosen intelligently among multiple agents.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having.” when used herein, can specify the presence of stated features, integers, steps, operations, elements, and/or components, but do not preclude the presence or addition of one or more other features, integers, steps, operations, elements, components, and/or groups thereof. As used herein, the phrase “in an embodiment” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
receiving an automatic triggering alert for changing a controller proxy in a computer cluster environment based on monitoring the computer cluster environment and policy rules associated with the computer cluster environment;
broadcasting the triggering alert to a plurality of agents in the computer cluster environment;
determining candidate proxies among the plurality of agents;
for each of the candidate proxies, determining a system health status based on a prediction model's forecast and determining a policy compliance score based on the policy rules;
based on the system health status and the policy compliance score associated with each of the candidate proxies, selecting a new controller proxy among the candidate proxies for the computer cluster environment; and
notifying the new controller proxy to perform management of the computer cluster environment.

2. The method of claim 1, wherein the determining candidate proxies among the plurality of agents includes receiving an indication of eligibility from the plurality of agents based on version numbers associated with the plurality of agents.

3. The method of claim 1, wherein the determining candidate proxies among the plurality of agents includes determining as the candidate proxies, agents that have the highest version numbers among the plurality of agents.

4. The method of claim 1, wherein the determining a system health status based on a prediction model's forecast includes generating a feature map using real time data associated with a candidate proxy among the candidate proxies, and inputting the feature map into the prediction model to forecast the system health status of the candidate proxy.

5. The method of claim 1, wherein the determining a policy compliance score based on the policy rules includes comparing the policy rules against a candidate proxy's current system attributes, computing the policy compliance score based on a number of the policy rules the candidate proxy is compliant with.

6. The method of claim 1, wherein the selecting a new controller proxy among the candidate proxies includes:
for each of the candidate proxies, computing a combined weighted score using the system health status and the policy compliance score; and
selecting candidate proxy having the highest combined weighted score as the new controller proxy.

7. The method of claim 1, further including training the prediction model to predict at least system resource usage and performance metric of an agent using historical information associated with the plurality of agents in the computer cluster environment.

8. A computer program product comprising a computer readable storage medium having program instructions embodied therewith, the program instructions readable by a device to cause the device to:
receive an automatic triggering alert for changing a controller proxy in a computer cluster environment based on monitoring the computer cluster environment and policy rules associated with the computer cluster environment;
broadcast the triggering alert to a plurality of agents in the computer cluster environment;
determine candidate proxies among the plurality of agents;
for each of the candidate proxies, determine a system health status based on a prediction model's forecast and determine a policy compliance score based on the policy rules;
based on the system health status and the policy compliance score associated with each of the candidate proxies, select a new controller proxy among the candidate proxies for the computer cluster environment; and
notify the new controller proxy to perform management of the computer cluster environment.

9. The computer program product of claim 8, wherein the device is caused to determine candidate proxies among the plurality of agents at least by receiving an indication of eligibility from the plurality of agents based on version numbers associated with the plurality of agents.

10. The computer program product of claim 8, wherein the device is caused to determine candidate proxies among the plurality of agents at least by determining as the candidate proxies, agents that have the highest version numbers among the plurality of agents.

11. The computer program product of claim 8, wherein the device is caused to determine a system health status based on a prediction model's forecast at least by generating a feature map using real time data associated with a candidate proxy among the candidate proxies, and inputting the feature map into the prediction model to forecast the system health status of the candidate proxy.

12. The computer program product of claim 8, wherein the device is caused to determine a policy compliance score based on the policy rules at least by comparing the policy rules against a candidate proxy's current system attributes, and computing the policy compliance score based on a number of the policy rules the candidate proxy is compliant with.

13. The computer program product of claim 8, wherein the device is caused to select a new controller proxy among the candidate proxies at least by:
for each of the candidate proxies, computing a combined weighted score using the system health status and the policy compliance score; and
selecting candidate proxy having the highest combined weighted score as the new controller proxy.

14. The computer program product of claim 8, wherein the device is further caused to train the prediction model to predict at least system resource usage and performance metric of an agent using historical information associated with the plurality of agents in the computer cluster environment.

15. A system comprising:
a processor; and
a memory coupled to the processor;
the processor configured to at least:
receive an automatic triggering alert for changing a controller proxy in a computer cluster environment based on monitoring the computer cluster environment and policy rules associated with the computer cluster environment;
broadcast the triggering alert to a plurality of agents in the computer cluster environment;
determine candidate proxies among the plurality of agents;
for each of the candidate proxies, determine a system health status based on a prediction model's forecast and determine a policy compliance score based on the policy rules;
based on the system health status and the policy compliance score associated with each of the candidate proxies, select a new controller proxy among the candidate proxies for the computer cluster environment; and
notify the new controller proxy to perform management of the computer cluster environment.

16. The system of claim 15, wherein the processor is configured to determine candidate proxies among the plurality of agents at least by receiving an indication of eligibility from the plurality of agents based on version numbers associated with the plurality of agents.

17. The system of claim 15, wherein the processor is configured to determine candidate proxies among the plurality of agents at least by determining as the candidate proxies, agents that have the highest version numbers among the plurality of agents.

18. The system of claim 15, wherein the processor is configured to determine a system health status based on a prediction model's forecast at least by generating a feature map using real time data associated with a candidate proxy among the candidate proxies, and inputting the feature map into the prediction model to forecast the system health status of the candidate proxy.

19. The system of claim 15, wherein the processor is configured to determine a policy compliance score based on the policy rules at least by comparing the policy rules against a candidate proxy's current system attributes, and computing the policy compliance score based on a number of the policy rules the candidate proxy is compliant with.

20. The system of claim 15, wherein the processor is configured to select a new controller proxy among the candidate proxies at least by:
for each of the candidate proxies, computing a combined weighted score using the system health status and the policy compliance score; and
selecting candidate proxy having the highest combined weighted score as the new controller proxy.
